(19) United States
(12) Patent Application Publication
(10) Pub. No.: US 2019/0186595 A1
(43) Pub. Date: Jun. 20, 2019

(54) LOAD BINDER

(71) Applicants: Prabhav Agarwalla, Solon, OH (US); Vibhav Agarwalla, Solon, OH (US)

(72) Inventors: Prabhav Agarwalla, Solon, OH (US); Vibhav Agarwalla, Solon, OH (US)

(21) Appl. No.: 15/848,235

(22) Filed: Dec. 20, 2017

(51) Int. Cl. F16G 11/12; B60P 7/08; F16H 31/00

(52) U.S. Cl. CPC F16G 11/12; F16H 31/002; B60P 7/0853

(57) ABSTRACT

A handle of a load binder. The handle includes a handle gear housing having a front end opposite a rear end. An outer handle gear is rotatably coupled within the handle gear housing. At least one drill connector 16 is extending laterally from the handle gear housing and is operable to rotate the outer handle gear when driven. A handle grip protrudes from the rear end of the handle gear housing. A binder gear housing protrudes from the front end of the handle gear housing. The binder gear housing includes an outer wall and a sidewall extending inward from the outer wall. The sidewall has a U-shaped cutout. The U-shaped cutout releasably receives a binder stem of the load binder and positions the outer handle gear to interlock with a binder gear of the load binder.

### BACKGROUND OF THE INVENTION

The present invention relates to a load binder and, more particularly, to a load binder which may be operated rapidly with a removable handle.

Load binders are well known for securing loads to trailers, other wheeled vehicles, or in other contexts as well. Typically, the load binder has end links or linkages which include hooks, each of which an operator may hook onto a chain or other tie down member or tie down point in order to tighten the chain, strap or other tie down member which is typically wrapped around a load mounted on a trailer.

Load binders come in several different types. One type of load binder is known as a lever-type load binder in which a lever is rotated or pivoted substantially along the plane in which the end links or linkages lie. Another type of load binder utilizes a ratchet system in which a sprocket is used to directly engage a chain of an end linkage whereby rotation of the sprocket tightens or loosens the chain and the ratchet mechanism secures the chain against loosening. Both of which operate rather slowly due to the necessity of manually rotating the levers and ratchets. Further, the handles are not removable, and therefore are susceptible to being stolen.

As can be seen, there is a need for a load binder which may be operated more rapidly with a removable handle.

### SUMMARY OF THE INVENTION

In one aspect of the present invention, a handle of a load binder, the handle comprises: a handle gear housing comprising a front end opposite a rear end; an outer handle gear rotatably coupled within the handle gear housing; at least one drill connector extending laterally from the handle gear housing and operable to rotate the outer handle gear when driven; a handle grip protruding from the rear end of the handle gear housing; and a binder gear housing protruding from the front end of the handle gear housing, the binder gear housing comprising an outer wall and a sidewall extending inward from the outer wall, the sidewall having a U-shaped cutout, wherein the U-shaped cutout releasably receives a binder stem of the load binder and positions the outer handle gear to interlock with a binder gear of the load binder.

In another aspect of the present invention, a handle of a load binder, the handle comprises: a handle gear housing comprising a front end opposite a rear end; an outer handle gear rotatably coupled within the handle gear housing; an inner handle gear rotatably coupled within the outer handle gear, wherein the inner handle gear interlocks with inner teeth of the outer handle gear; at least one drill connector extending laterally from the handle gear housing and fixedly connected with the inner handle gear; a handle grip protruding from the rear end of the handle gear housing; and a binder gear housing protruding from the front end of the handle gear housing, the binder gear housing comprising an outer wall and a sidewall extending inward from the outer wall, the sidewall having a U-shaped cutout, wherein the U-shaped cutout releasably receives a binder stem of the load binder and positions the outer handle gear to interlock with a binder gear of the load binder.

These and other features, aspects and advantages of the present invention will become better understood with reference to the following drawings, description and claims.

### BRIEF DESCRIPTION OF THE DRAWINGS

FIG. 1 is an exploded view of an embodiment of the present invention;

FIG. 2 is a perspective view of an embodiment of the present invention;

FIG. 3 is a detail perspective view of an embodiment of the present invention;

FIG. 4 is a detail perspective view of an embodiment of the present invention;

FIG. 5 is perspective view of an embodiment of the present invention;

FIG. 6 is a perspective view of an embodiment of the present invention in use;

FIG. 7 is a detail section view of the present invention taken along line 7-7 in FIG. 5;

FIG. 8 is a detail section view of the present invention taken along line 8-8 in FIG. 6;

FIG. 9 is a section view of the present invention taken along line 9-9 in FIG. 2 in a loosened position;

FIG. 10 is a section view of the present invention in a tightened position; and

FIG. 11 is a detail view of an embodiment of the present invention being used with a power drill.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

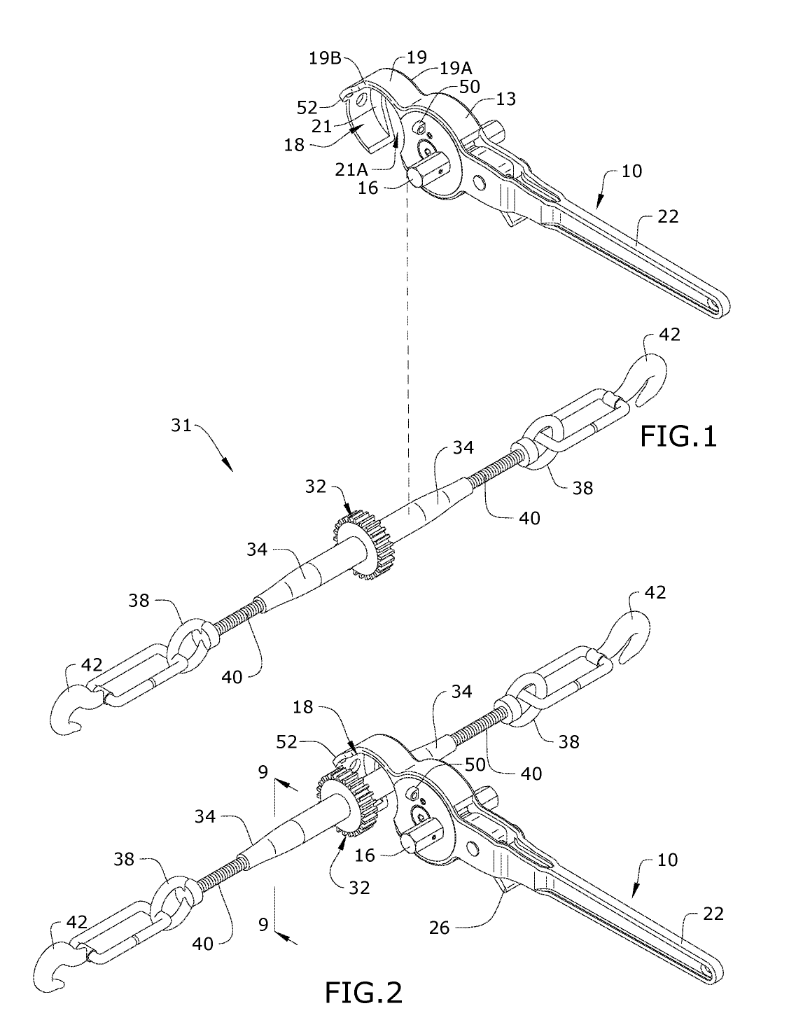

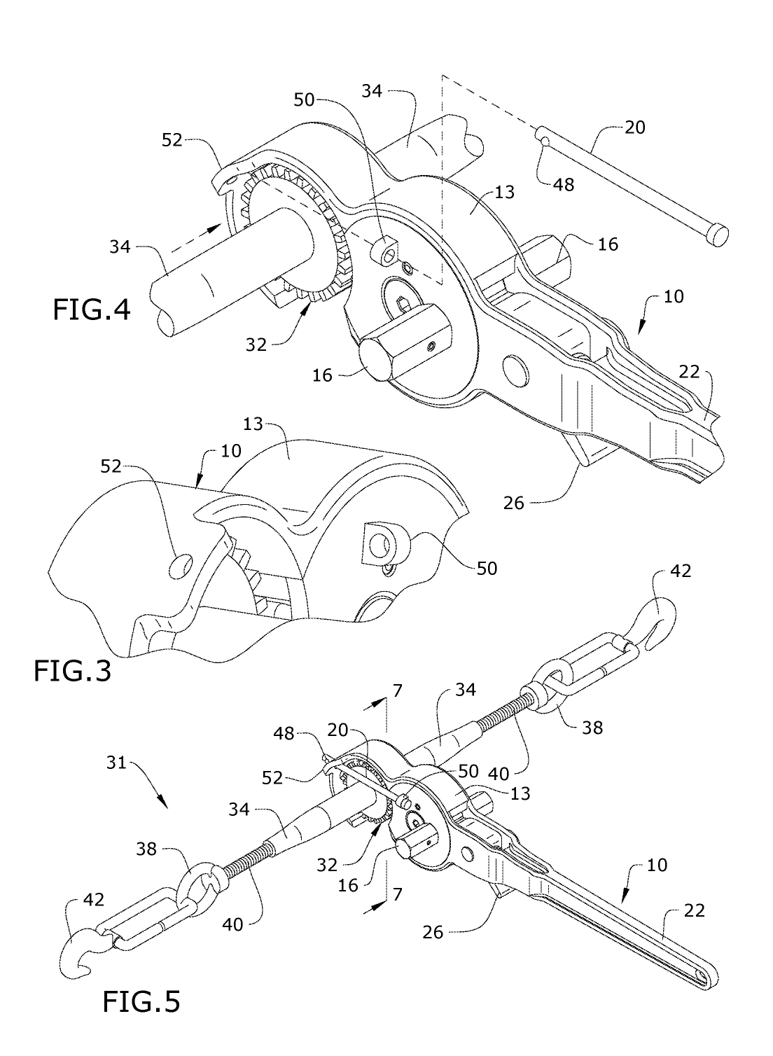

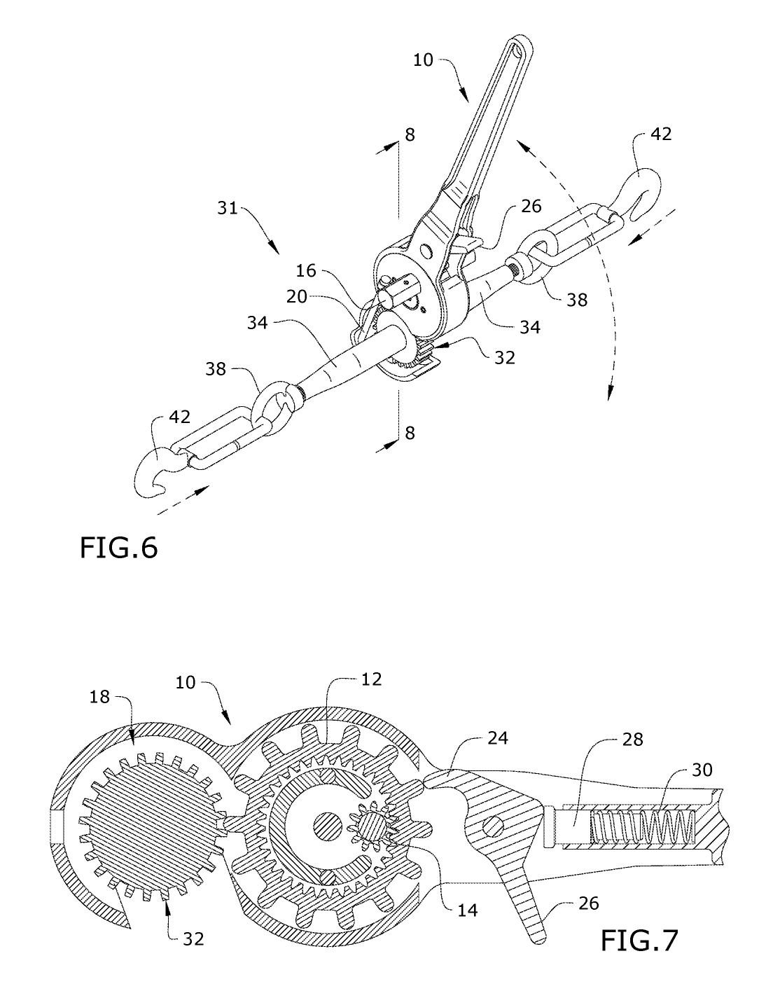

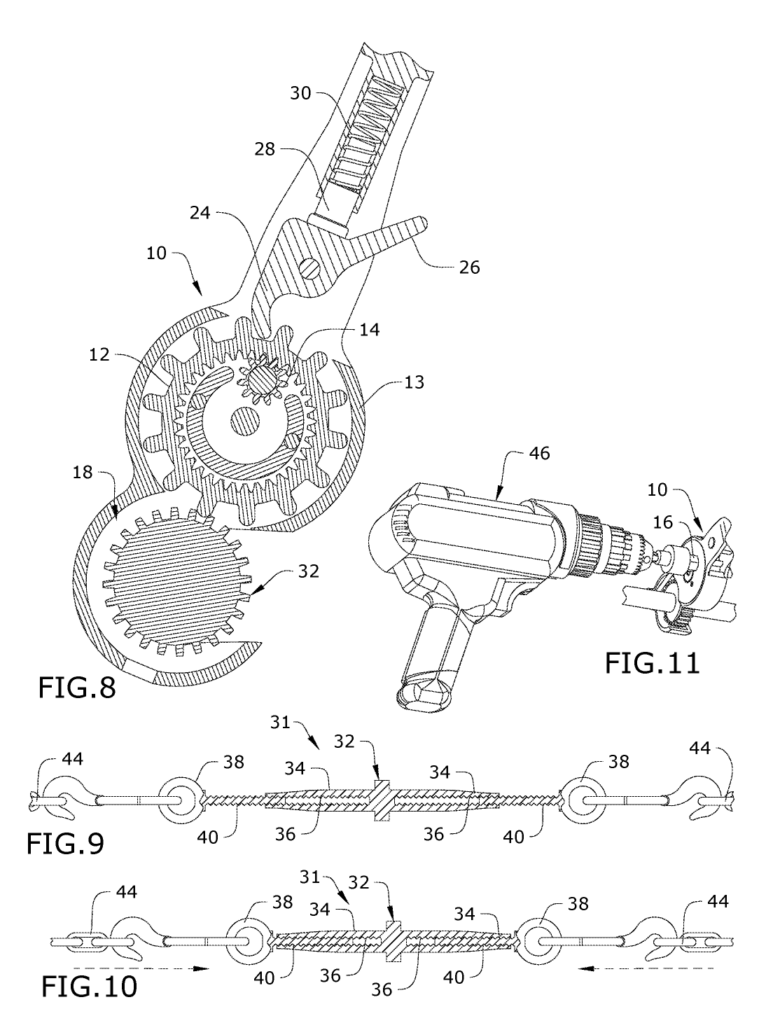

Referring to FIGS. 1 through 11, the present invention includes a handle 10 of a load binder 31. The handle 10 includes a handle gear housing 13 having a front end opposite a rear end. An outer handle gear 12 is rotatably coupled within the handle gear housing 13. At least one drill connector 16 is extending laterally from the handle gear housing 13 and is operable to rotate the outer handle gear 12 when driven. A handle grip 22 protrudes from the rear end of the handle gear housing 13. A binder gear housing 18 protrudes from the front end of the handle gear housing 13. The binder gear housing 18 includes an outer wall 19 and a sidewall 21 extending inward from the outer wall 19. The sidewall 21 has a U-shaped cutout 21a. The U-shaped cutout 21a releasably receives a binder stem 34 of the load binder 31 and positions the outer handle gear 12 to interlock with a binder gear 32 of the load binder 31.

In certain embodiments, the present invention further includes an inner handle gear 14. The inner handle gear 14 is rotatably coupled within the outer handle gear. In such embodiments, the outer handle gear 12 may include inner teeth circumferentially protruding from an inner edge of the outer handle gear 12. The teeth of the inner handle gear 14 interlock with the inner teeth of the outer handle gear 12. The drill connector 16 of the present invention is fixed to the inner handle gear 14. Therefore, a power drill 46 may connect with the drill connector 16 and rotate the inner handle gear 14, thereby rotating the outer handle gear 12.

The at least one drill connector 16 may include a first drill connector 16 and a second drill connector 16. The first drill connector 16 may extend laterally from a first side of the handle gear housing 13 and a second drill connector 16 may extend laterally from a second side of the handle gear housing 13. The drill connectors 16 are used to connect with a mating end of a power drill 46. For example, the drill connectors 16 are in the shape of a nut, such as a six-sided nut. Alternatively, the drill connectors 16 may include phillips head or flat head screw indents or other types of connectors.

The binder gear housing 18 is used to releasably connect with the load binder 31 and position the outer handle gear 12 to interlock with the binder gear 32. In certain embodiments, the outer wall 19 of the binder gear housing 18 is rounded to form a circular shape to uniformly surround the binder gear 32. The outer wall 19 of the binder gear housing 18 further includes a cutout portion that intersects with the U-shaped cutout portion 21a of the sidewall 21. The outer wall 19 further includes a first circular edge 19a opposite a second circular edge 19b. The sidewall 21 inward protrudes from the first circular edge 19a. The second circular edge 19b forms an opening sized to laterally receive the binder gear 32 of the load binder 31. Therefore, the circumference of the second circular edge 19b is greater than an outer circumference of the binder gear 32. When releasably attaching the handle 10 to the load binder 31, the user may first place the U-shaped cutout 21a over the binder stem 34 and then shift the handle 10 laterally along the binder stem 34 so that the binder gear 32 slides into the binder gear housing 18.

The present invention may further include a housing lock to lock the binder gear housing 18 in place relative to the loading binder 31. In such embodiments, the present invention may include a first receiver 52 formed in the binder gear housing 18, a second receiver 50 formed on an outer surface of the handle gear housing 13, and a lock pin 20. The lock pin 20 includes a first end that slides into the first receiver 52 and a second end that slides into the second receiver 50 so that the lock pin 20 is disposed across the opening formed by the second circular edge 19b. A spring lock pin 48 may prevent the ends of the lock pin 20 from sliding out of the first and second receivers 52, 50. When the binder gear housing 18 is disposed over the binder gear 32 and the lock pin 20 is disposed within the receivers 52, 50, the lock pin 20 prevents the handle 10 from shifting and misaligning the outer handle gear 12 and the binder gear 32.

The present invention may further include a lock lever 24, 26 pivotally coupled to the handle 10 in between the handle grip 22 and the handle gear housing 13. The lock lever 24, 26 includes a lock 24 adjacent the outer handle gear 12 and a lever 26 extending outside of the handle 10. When urging the lever 26 in a first direction, the lock lever 24, 26 pivots the lock 24 to a locked position in which the lock 24 is interlocked with the outer handle gear 12. When urging the lever 26 in an opposite direction, the lock lever 24, 26 pivots the lock 24 to an unlocked position in which the lock 24 is pivoted away from the outer handle gear 12 allowing the outer handle gear 12 to rotate freely. In certain embodiments, the present invention may further include a lock pin 28 and a spring 30 biasing the lock pin against the lock lever 24, 26 which biases the lock lever 24, 26 in the locked position.

The loading binder 31 used with the present invention may include the binder stem 34 having a first end and a second end. Each of the first end and second end include hollow cores with internal threads 36. The binder gear 32 is fixedly secured to the binder stem 34 so that the binder stem 24 and the binder gear 32 rotate together about a common axis. The loading binder 31 further includes a first connector and a second connector. The first connector and the second connector each include threaded rods 40, eye-bolts 38 and binder hooks 42. The first and second threaded rods 40 are threadably connected to the first end and the second end of the binder stem 34 respectively.

When in use, the hooks 42 of the loading binder 31 are connected to chains 44 or straps to be tightened together. The U-shaped cutout 21a of the handle 10 is placed over the binder stem 34 so that the opening of the binder gear housing 18 is facing the binder gear 32. The handle 10 is slid in a direction of the binder gear 32 so that the binder gear housing 18 fits over the binder gear 32 and the outer handle gear 12 is interlocked with the binder gear 32. The pin 20 is placed within the receivers 50, 52 to lock the handle 10 in place relative to the binder gear 32. The lock lever 24, 26 is pivoted to allow the outer handle gear 12 to rotate freely. A connecting end of the power drill 46 mates with the power drill connector 16 and the power drill 46 is turned on. The inner handle gear 14 is rotated, which rotates the outer handle gear 12 and in turn rotates the binder gear 32. As illustrated in FIG. 10, the threaded connections are tightened, which in turn tightens the chains 44 together. To loosen the loading binder 31, the steps above are performed with the power drill rotating the power drill connector 16 in an opposite direction.

It should be understood, of course, that the foregoing relates to exemplary embodiments of the invention and that modifications may be made without departing from the spirit and scope of the invention as set forth in the following claims.

What is claimed is:

1. A handle of a load binder, the handle comprising:
a handle gear housing comprising a front end opposite a rear end;
an outer handle gear rotatably coupled within the handle gear housing;
at least one drill connector extending laterally from the handle gear housing and operable to rotate the outer handle gear when driven;
a handle grip protruding from the rear end of the handle gear housing; and
a binder gear housing protruding from the front end of the handle gear housing, the binder gear housing comprising an outer wall and a sidewall extending inward from the outer wall, the sidewall having a U-shaped cutout, wherein
the U-shaped cutout releasably receives a binder stem of the load binder and positions the outer handle gear to interlock with a binder gear of the load binder.

2. The handle of claim 1, further comprising an inner handle gear rotatably coupled within the outer handle gear, wherein the inner handle gear interlocks with inner teeth of the outer handle gear and the inner handle gear is fixedly coupled to the at least one drill nut.

3. The handle of claim 1, wherein the at least one drill connector comprises a first drill connector extending laterally from a first side of the handle gear housing and a second drill connector extending laterally from a second side of the handle gear housing.

4. The handle of claim 1, wherein the outer wall of the binder gear housing is rounded to form a circular shape with a cutout portion that intersects with the U-shaped cutout portion of the sidewall.

5. The handle of claim 4, wherein the outer wall of the binder gear housing comprises a first circular edge opposite a second circular edge, wherein the sidewall protrudes from the first circular edge and the second circular edge forms an opening sized to laterally receive the binder gear of the load binder.

6. The handle of claim 5, further comprising a housing lock, the housing lock comprising a first receiver formed in the binder gear housing, a second receiver formed on an outer surface of the handle gear housing, and a lock pin comprising a first end sized to fit within the first receiver and a second end sized to fit within the second receiver so that the lock pin is disposed across the opening formed by the second circular edge.

7. The handle of claim 1, further comprising a lock lever pivotally coupled in between the handle grip and the handle gear housing, wherein the lock lever comprises a lock adjacent the outer handle gear and a lever extending outside of the handle, wherein the lever is operable to pivot the lock in a first direction to a locked position comprising the lock interlocked with the outer handle gear and to pivot the lock lever in a second direction to an unlocked position comprising the lock pivoted away from the outer handle gear.

8. The handle of claim 7, further comprising a lock pin and a spring biasing the lock pin against the lock lever in the locked position.

9. A handle of a load binder, the handle comprising:
a handle gear housing comprising a front end opposite a rear end;
an outer handle gear rotatably coupled within the handle gear housing;
an inner handle gear disposed within the outer handle gear, wherein the inner handle gear interlocks with inner teeth of the outer handle gear;
at least one drill connector extending laterally from the handle gear housing and fixedly connected with the inner handle gear;
a handle grip protruding from the rear end of the handle gear housing; and
a binder gear housing protruding from the front end of the handle gear housing, the binder gear housing comprising an outer wall and a sidewall extending inward from the outer wall, the sidewall having a U-shaped cutout, wherein
the U-shaped cutout releasably receives a binder stem of the load binder and positions the outer handle gear to interlock with a binder gear of the load binder.

10. The handle of claim 9, further comprising a lock lever pivotally coupled in between the handle grip and the handle gear housing, wherein the lock lever comprises a lock adjacent the outer handle gear and a lever extending outside of the handle, wherein the lever is operable to pivot the lock in a first direction to a locked position comprising the lock interlocked with the outer handle gear and to pivot the lock lever in a second direction to an unlocked position comprising the lock pivoted away from the outer handle gear.
